(19) United States
(12) Patent Application Publication
(10) Pub. No.: US 2026/0326396 A1
(43) Pub. Date: Oct. 22, 2026

(54) METHOD FOR MANUFACTURING LAMINATED MEMBER

(71) Applicant: TOKAI CHEMICAL INDUSTRIES, LTD., Gifu (JP)

(72) Inventors: Takemasa OKUMURA, Gifu (JP); Yosuke Naruse, Gifu (JP)

(73) Assignee: TOKAI CHEMICAL INDUSTRIES, LTD., Gifu (JP)

(21) Appl. No.: 19/696,348

(22) Filed: Jun. 3, 2026

Related U.S. Application Data
(63) Continuation of application No. PCT/JP2024/043304, filed on Dec. 6, 2024.

(30) Foreign Application Priority Data
Dec. 28, 2023 (JP) 2023-223118

(51) Int. Cl. B29D 7/00

(52) U.S. Cl. CPC B29D 7/00; B29K 2995/0026

(57) ABSTRACT

In a method for manufacturing a laminated member, a laminated member, which includes a printed layer having a to-be-molded surface that includes a grain part having an uneven shape and a printed surface facing away from the to-be-molded surface, and a printing layer printed onto the printed surface, is manufactured using a molding die member having a molding surface that includes a back grain part having an uneven shape and being die-symmetric with respect to the grain part. The method for manufacturing a laminated member includes a molding process in which the to-be-molded surface is molded by the molding surface, and a printing process in which the printing layer is printed onto the printed surface while the to-be-molded surface is in close contact with the molding surface.

### CROSS-REFERENCE TO RELATED APPLICATION

This application is a continuation of PCT International Application No. PCT/JP2024/043304, filed on Dec. 6, 2024, which claims priority under 35 U.S. C § 119(a) to Japanese Patent Application No. 2023-223118, filed on Dec. 28, 2023. Each of the above application(s) is hereby expressly incorporated by reference, in its entirety, into the present application.

### BACKGROUND

### Technical Field

The present disclosure relates to a method for manufacturing a laminated member, in which the laminated member is manufactured by laminating each layer using printing.

### Related Art

As shown in Japanese Patent Laid-Open No. 2022-157890, a decorative sheet used for an interior member of a vehicle includes a skin layer, an intermediate layer, and a design layer. A grain part having an uneven shape is formed on a front surface of the skin layer. The intermediate layer is printed onto a back surface of the skin layer. The design layer is printed onto a back surface of the intermediate layer.

The decorative sheet is manufactured, for example, by the following manufacturing method. First, the skin layer is set on a printing table of a printing machine such that the front surface faces downward (such that the back surface faces upward). Next, the intermediate layer is printed onto the back surface (upper surface) of the skin layer. Then, the design layer is printed onto the back surface (upper surface) of the intermediate layer. In this way, the decorative sheet is manufactured using printing.

However, during printing, only vertices of convex portions of the grain part on the front surface (lower surface) of the skin layer are in contact with an upper surface of the printing table. In other words, the skin layer is supported by the printing table from below only by the vertices of the convex portions of the grain part.

During printing, a load (such as printing pressure) is applied to the skin layer from above. The vertices of the convex portions of the grain part are supported by the printing table from below. Hence, a portion of the back surface of the skin layer that corresponds to the vertices of the convex portions is unlikely to deform even if the load is applied thereto. On the other hand, portions (for example, concave portions of the grain part) other than the vertices of the convex portions are not supported by the printing table from below. Hence, a portion of the back surface of the skin layer that corresponds to the portions other than the vertices of the convex portions is likely to deform when the load is applied thereto. Accordingly, printing accuracy of the intermediate layer and the design layer is likely to decrease. Accordingly, it is desired to provide a method for manufacturing a laminated member in which a decrease in printing accuracy can be suppressed.

### SUMMARY

Provided is a method for manufacturing a laminated member as described below. The laminated member includes a printed layer and a printing layer, the printed layer having a to-be-molded surface that includes a grain part having an uneven shape, and a printed surface facing away from the to-be-molded surface, the printing layer being printed onto the printed surface. In the method, the laminated member is manufactured using a molding die member having a molding surface that includes a back grain part having an uneven shape and being die-symmetric with respect to the grain part. The method includes: a molding process in which the to-be-molded surface is molded by the molding surface; and a printing process in which the printing layer is printed onto the printed surface while the to-be-molded surface remains in close contact with the molding surface. The laminated member is a decorative sheet including a skin layer having a light transmitting property, an intermediate layer having a light transmitting property and arranged on a back side of the skin layer, and a design layer having a light transmitting property and arranged on a back side of the intermediate layer. The printed layer is the skin layer, the to-be-molded surface is a front surface of the skin layer, and the printed surface is a back surface of the skin layer. The printing layer is the intermediate layer. The printing process is an intermediate layer printing process in which the intermediate layer is printed onto the back surface of the skin layer while the front surface of the skin layer remains in close contact with the molding surface. The method further includes a design layer printing process in which the design layer is printed onto a back surface of the intermediate layer.

### BRIEF DESCRIPTION OF THE DRAWINGS

FIG. 1 is a partial perspective view of a door trim in which a decorative sheet manufactured by a method for manufacturing a laminated member of one embodiment of a method for manufacturing a laminated member of the present disclosure is arranged.

FIG. 2 is a perspective view inside a frame II of FIG. 1.

FIG. 3 is an exploded perspective view inside the frame II of FIG. 1.

FIG. 4 is a cross-sectional view taken along IV-IV of FIG. 2.

FIG. 5A is a schematic view of a molding process of the method for manufacturing a laminated member. FIG. 5B is a schematic view of an intermediate layer printing process of the method for manufacturing a laminated member.

FIG. 6A is a schematic view of a design layer printing process of the method for manufacturing a laminated member. FIG. 6B is a schematic view of a demolding process of the method for manufacturing a laminated member.

### DESCRIPTION OF THE EMBODIMENTS

(1) A method for manufacturing a laminated member of the present disclosure is a method for manufacturing a laminated member as described below. The laminated member includes a printed layer and a printing layer, the printed layer having a to-be-molded surface that includes a grain part having an uneven shape, and a printed surface facing away from the to-be-molded surface, the printing layer being printed onto the printed surface. In the method, the laminated member is manufactured using a molding die member having a molding surface that includes a back grain part having an uneven shape and being die-symmetric with respect to the grain part. The method is characterized by including: a molding process in which the to-be-molded surface is molded by the molding surface; and a printing process in which the printing layer is printed onto the printed surface while the to-be-molded surface remains in close contact with the molding surface.

According to the present configuration, in the printing process, the printing layer is printed onto the printed surface while the to-be-molded surface remains in close contact with the molding surface. That is, the printing layer is printed onto the printed surface while the to-be-molded surface is entirely supported by the molding surface (specifically, while convex portions of the grain part are supported by concave portions of the back grain part and concave portions of the grain part are supported by convex portions of the back grain part, respectively). Hence, the printed surface is less likely to deform compared to a case where only vertices of the convex portions of the grain part are supported. Variation in load distribution on the printed surface is less likely to occur compared to the case where only the vertices of the convex portions of the grain part are supported. Thus, a decrease in printing accuracy of the printing layer with respect to the printed surface can be suppressed.
(1-1) In the configuration of (1) above, preferably, the molding die member is a grain transfer separator, and the molding surface of the grain transfer separator has a configuration having releasability with respect to the to-be-molded surface. According to the present configuration, after the printing process, the grain transfer separator can be easily peeled from the to-be-molded surface.
(2) In the configuration of (1) or (1-1) above, preferably, the laminated member is a decorative sheet including a skin layer having a light transmitting property, an intermediate layer having a light transmitting property and arranged on a back side of the skin layer, and a design layer having a light transmitting property and arranged on a back side of the intermediate layer. The printed layer is the skin layer. The to-be-molded surface is a front surface of the skin layer. The printed surface is a back surface of the skin layer. The printing layer is the intermediate layer. The printing process is an intermediate layer printing process in which the intermediate layer is printed onto the back surface of the skin layer while the front surface of the skin layer remains in close contact with the molding surface. The configuration further includes a design layer printing process in which the design layer is printed onto a back surface of the intermediate layer.

According to the present configuration, variation in layer thickness of the intermediate layer can be suppressed compared to, for example, a case where the intermediate layer is arranged by coating. The intermediate layer can be suppressed from being excessively increased in layer thickness. The same applies to the design layer. Positional deviation in a layer direction (layer development direction; a direction intersecting a lamination direction) among the three layers (skin layer, intermediate layer, and design layer) can be suppressed.

According to the method for manufacturing a laminated member of the present disclosure, a decrease in printing accuracy can be suppressed.

Hereinafter, embodiments of a method for manufacturing a laminated member of the present disclosure will be described.

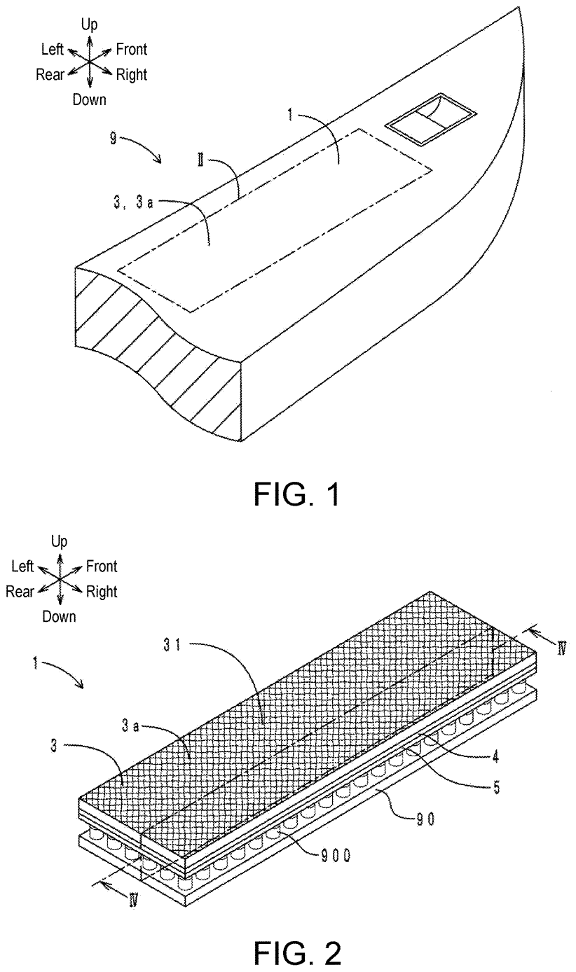

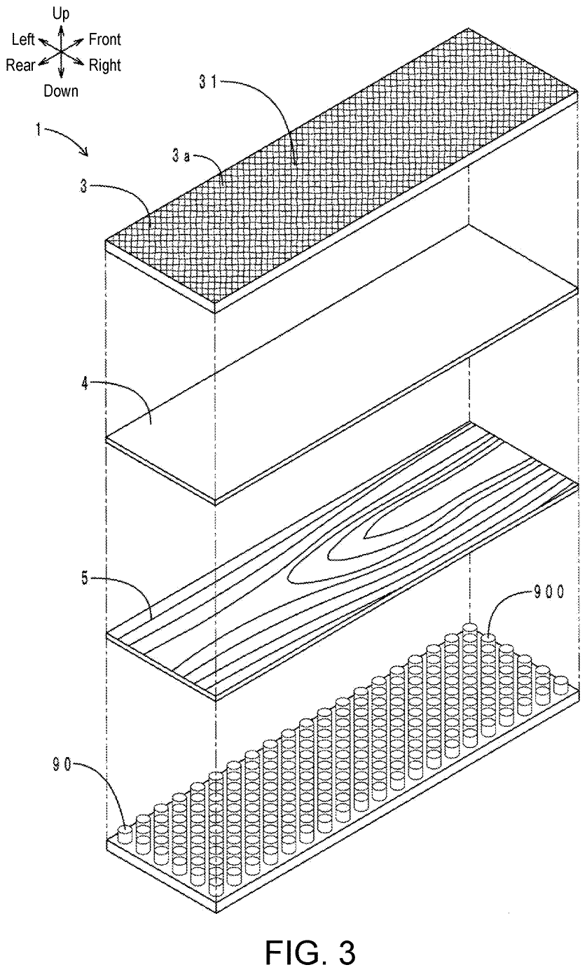

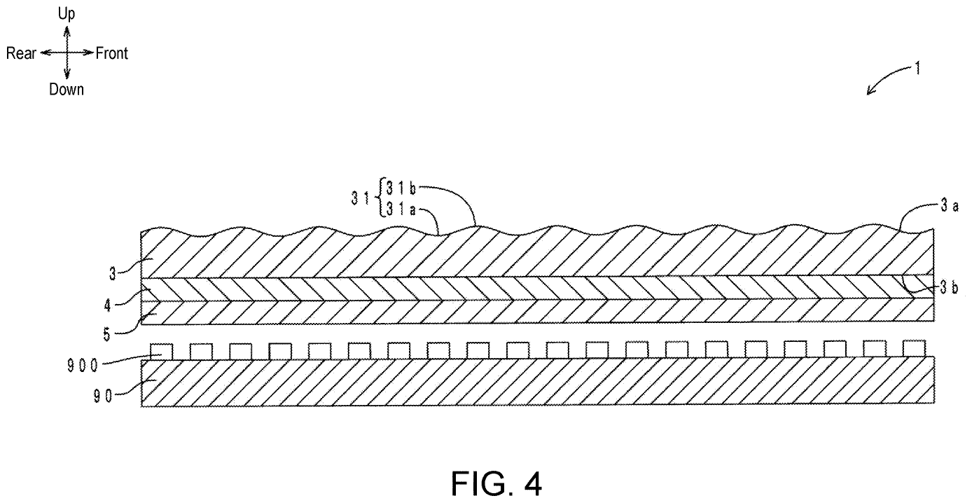

FIG. 1 shows a partial perspective view of a door trim in which a decorative sheet (hereinafter referred to as “decorative sheet of the present embodiment” as appropriate) manufactured by a method for manufacturing a laminated member of one embodiment of a method for manufacturing a laminated member of the present disclosure is arranged. FIG. 2 shows a perspective view inside a frame II of FIG. 1. FIG. 3 shows an exploded perspective view inside the frame II of FIG. 1. FIG. 4 shows a cross-sectional view (front-back direction cross-sectional view) taken along IV-IV of FIG. 2. In FIG. 2 to FIG. 4, a grain part 31 is schematically shown.

### Arrangement and Configuration of Decorative Sheet

First, an arrangement and configuration of a decorative sheet of the present embodiment are described. As shown in FIG. 1, a decorative sheet (laminated member) 1 is arranged on a door trim 9 of a vehicle cabin. As shown in FIG. 1 to FIG. 4, the door trim 9 includes the decorative sheet 1 and a light source part 90. The decorative sheet 1 and the light source part 90 are laminated in this order from a front side (upper side; vehicle cabin interior side) toward a back side (lower side; vehicle cabin exterior side).

As shown in FIG. 3 to FIG. 4, the decorative sheet 1 includes, from the front side toward the back side, a skin layer (printed layer) 3, an intermediate layer (printing layer) 4, and a design layer 5. The skin layer 3 is made of synthetic resin and exhibits a layer shape. The skin layer 3 has a light transmitting property and flexibility. The skin layer 3 includes a front surface (to-be-molded surface; upper surface) 3a and a back surface (printed surface; lower surface) 3b. The front surface 3a and the back surface 3b face away from each other in a front-back direction. The front surface 3a includes multiple grain parts 31 having an uneven shape. That is, the grain part 31 includes a concave portion 31a recessed downward and a convex portion 31b protruding upward. The back surface 3b is a flat surface (smooth surface) that does not include the grain part 31. As shown in FIG. 1, the front surface 3a is exposed in the vehicle cabin. Light is irradiated from the light source part 90 on the back side to the design layer 5 described later. By the light, a wood grain pattern of the design layer 5 is displayed on the front surface 3a of the skin layer 3.

The intermediate layer 4 is printed onto the back surface 3b of the skin layer 3. The intermediate layer 4 is made of light transmitting ink and exhibits a layer shape. The intermediate layer 4 has a light transmitting property and flexibility. The intermediate layer 4 has a lower light transmitting property than the skin layer 3. The intermediate layer 4 is smoke-toned translucent. The intermediate layer 4 is colored transparent.

The design layer 5 is printed onto a back surface of the intermediate layer 4. The design layer 5 is made of light transmitting ink and exhibits a layer shape. The design layer 5 has a light transmitting property and flexibility. The design layer 5 has a higher light transmitting property than the intermediate layer 4. The design layer 5 displays a wood grain pattern when viewed from the front side.

The light source part 90 is arranged on the back side of the design layer 5. The light source part 90 includes multiple light sources (LEDs) 900. The multiple light sources 900 are distributed throughout a layer direction (layer development direction; direction intersecting a lamination direction; surface direction) of the light source part 90. A front surface of the light source part 90 is capable of emitting light over the entire surface. Light from the light sources 900 reaches a front surface (that is, the front surface 3a of the skin layer 3) of the door trim 9 via the design layer 5, the intermediate layer 4, and the skin layer 3.

In the case where the light source part 90 is off, the light sources 900 are turned off. That is, the backlight with respect to the decorative sheet 1 is in an off state. Here, the light transmitting property of each layer is set in order from high to low as follows: the skin layer 3 (through which light is most likely to be transmitted), the design layer 5, and the intermediate layer 4 (through which light is least likely to be transmitted). Hence, it is difficult for a user to visually recognize the wood grain pattern of the design layer 5 from the front side (vehicle interior) of the decorative sheet 1. It is easy for a user to integrally visually recognize a three-dimensional shape of the grain part 31 of the skin layer 3 and the color of the intermediate layer 4 from the front side (vehicle interior) of the decorative sheet 1.

In the case where the light source part 90 is on, the light sources 900 are turned on. That is, the backlight with respect to the decorative sheet 1 is in an on state. As described above, the light transmitting property of each layer is set in order from high to low as follows: the skin layer 3, the design layer 5, and the intermediate layer 4. Hence, it is easy for the user to visually recognize the wood grain pattern of the design layer 5 from the front side of the decorative sheet 1. In this way, the decorative sheet 1 is able to display two types of designs on the front surface 3a of the skin layer 3 in response to on and off of the light source part 90.

### Method for Manufacturing Laminated Member

Next, the method for manufacturing a laminated member of the present embodiment will be described. The method for manufacturing a laminated member includes a molding process, an intermediate layer printing process, a design layer printing process, and a demolding process. The method for manufacturing a laminated member is performed in a state in which the decorative sheet 1 shown in FIG. 1 to FIG. 4 is inverted upside down.

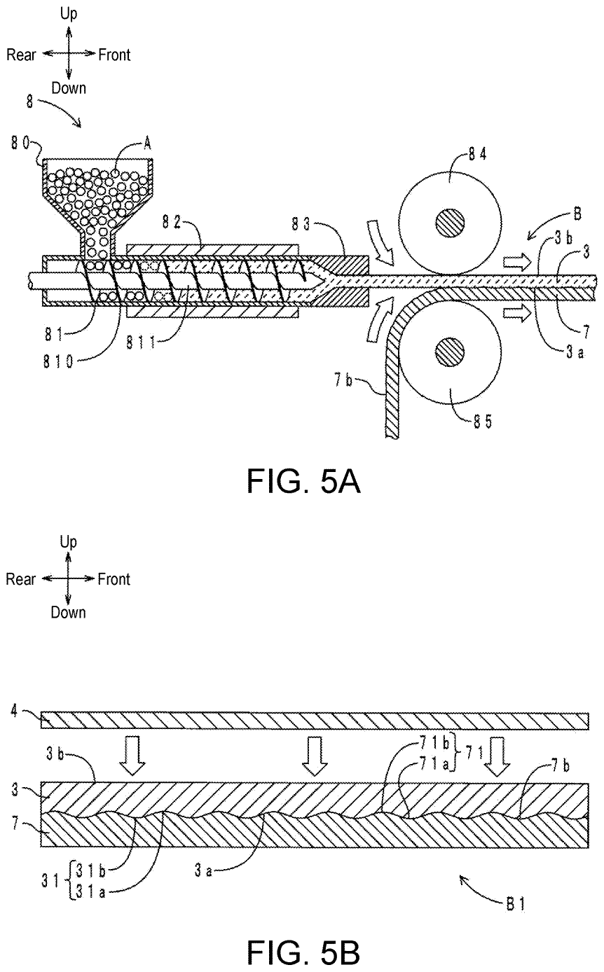

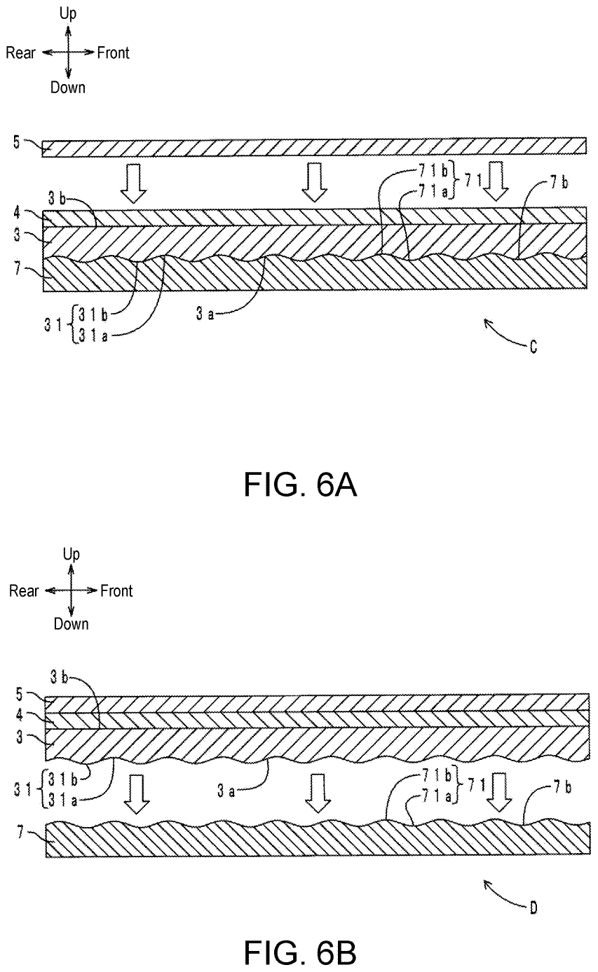

FIG. 5A shows a schematic diagram of the molding process of the method for manufacturing a laminated member of the present embodiment. FIG. 5B shows a schematic diagram of the intermediate layer printing process of the aforesaid method for manufacturing a laminated member. FIG. 6A shows a schematic diagram of the design layer printing process of the aforesaid method for manufacturing a laminated member. FIG. 6B shows a schematic diagram of the demolding process of the aforesaid method for manufacturing a laminated member.

### Molding Process

In the present process, the skin layer 3 is produced, and the grain part 31 is molded on the front surface 3a of the skin layer 3. As shown in FIG. 5A, a molding device 8 includes a hopper 80, a screw feeder 81, a heater 82, a die 83, and a pair of rollers 84, 85. In the hopper 80, a raw material (synthetic resin raw material) A of the skin layer 3 is stored. The screw feeder 81 includes a pipe 810 and a screw shaft 811. The hopper 80 is connected near a rear end (upstream end) of a side peripheral wall of the pipe 810. The screw shaft 811 is rotatable around its own axis and is inserted through the pipe 810. The heater 82 is mounted around the side peripheral wall of the pipe 810. The die 83 is connected to an opening at a front end (downstream end) of the pipe 810. The pair of rollers 84, 85 are arranged on a front side of the die 83. The pair of rollers 84, 85 are arranged spaced apart from and facing each other.

In the present process, the raw material A is supplied by its own weight from the hopper 80 to the screw feeder 81. The raw material A having a pellet shape (in a solid state) is conveyed from a rear side toward the front side by a screw of the screw shaft 811. During conveyance, the raw material A is softened and melted by heat transferred from the heater 82, and changes to a fluid state (gel state; syrup-like state). The raw material A in a gel state is molded into a strip shape by the die 83. The molded raw material A merges with a grain transfer separator 7 supplied from a lower side and passes between the pair of rollers 84, 85. On a back surface (molding surface; release surface; upper surface) 7b of the grain transfer separator 7, a back grain part 71 (see FIG. 5B) having an uneven shape is arranged in advance. The grain transfer separator 7 is included in the concept of “molding die member” of the present disclosure. The back surface 7b is included in the concept of “molding surface” of the present disclosure.

When passing between the pair of rollers 84, 85, the raw material A on the upper side and the grain transfer separator 7 on the lower side are laminated, and a laminated sheet B having a strip shape is produced. The front surface (to-be-molded surface; lower surface) 3a of the raw material A and the back surface 7b of the grain transfer separator 7 are crimped. By the crimping, the shape of the back grain part 71 is transferred to the front surface 3a, and the grain part 31 (see FIG. 5B) is molded on the front surface 3a.

Specifically, as shown in FIG. 5B, the back grain part 71 includes a concave portion 71a recessed downward and a convex portion 71b protruding upward. By the concave portion 71a, the convex portion 31b is molded on the front surface 3a. By the convex portion 71b, the concave portion 31a is molded on the front surface 3a. Thus, the grain part 31 (concave portion 31a, convex portion 31b) exhibits an uneven shape that is die-symmetric with respect to the back grain part 71 (concave portion 71a, convex portion 71b). As shown in FIG. 5A, a surface of the roller 84 on the upper side is a flat surface. Hence, the back surface (printed surface; upper surface) 3b of the raw material A is molded into a flat surface by pressure contact with the roller 84. After passing between the pair of rollers 84, 85, the raw material A is solidified by cooling (natural cooling). In this way, the skin layer 3 with the grain part 31 is produced.

### Intermediate Layer Printing Process

In the present process, the intermediate layer 4 is printed onto the back surface 3b of the skin layer 3 while the back surface 7b of the grain transfer separator 7 remains in close contact with the front surface 3a of the skin layer 3. Specifically, as shown in FIG. 5B, a laminate (laminate of the skin layer 3 and the grain transfer separator 7) B1 obtained by cutting the laminated sheet (laminated sheet of the skin layer 3 and the grain transfer separator 7) B shown in FIG. 5A into a predetermined shape is placed on a printing table (not shown), and the intermediate layer 4 is printed onto the back surface 3b of the skin layer 3 by a silk screen printing machine (not shown). In the case where the intermediate layer 4 exhibits a multilayer structure (for example, a structure including a surface layer (transparent layer) on the skin layer 3 side and a back layer (colored layer) on the design layer 5 side), each layer is printed in sequence.

### Design Layer Printing Process

In the present process, as shown in FIG. 6A, similarly to the intermediate layer printing process, the design layer 5 is printed onto a back surface (upper surface) of the intermediate layer 4 of a laminate (laminate of the intermediate layer 4, the skin layer 3, and the grain transfer separator 7) C by a silk screen printing machine (not shown) while the back surface 7b of the grain transfer separator 7 remains in close contact with the front surface 3a of the skin layer 3. In the case where the design layer 5 exhibits a multilayer structure (for example, a structure that forms a wood grain pattern when viewed from the front side by laminating multiple layers), each layer is printed in sequence.

### Demolding Process

In the present process, as shown in FIG. 6B, the grain transfer separator 7 is peeled off from a laminate (laminate of the design layer 5, the intermediate layer 4, the skin layer 3, and the grain transfer separator 7) D after printing of the design layer 5. The back surface 7b of the grain transfer separator 7 has releasability with respect to the front surface 3a of the skin layer 3. Hence, the grain transfer separator 7 can be easily peeled off. In this way, the decorative sheet 1 of the present embodiment is produced.

### Effects

Next, the effects of the method for manufacturing a laminated member of the present embodiment are described. As shown in FIG. 5B, in the intermediate layer printing process, the intermediate layer 4 is printed onto the back surface 3b of the skin layer 3 while the back surface 7b of the grain transfer separator 7 remains in close contact with the front surface 3a of the skin layer 3. That is, the intermediate layer 4 is printed onto the back surface 3b while the front surface 3a is entirely supported by the back surface 7b (specifically, while the convex portions 31b of the grain part 31 are supported by the concave portions 71a of the back grain part 71, and the concave portions 31a of the grain part 31 are supported by the convex portions 71b of the back grain part 71, respectively). Hence, the back surface 3b is less likely to deform compared to a case where only vertices of the convex portions 31b of the grain part 31 are supported (case where the grain transfer separator 7 is not arranged). Compared to a case where only the vertices of the convex portions 31b of the grain part 31 are supported, variation in load distribution on the back surface 3b is less likely to occur during printing of the intermediate layer 4. Thus, a decrease in printing accuracy of the intermediate layer 4 with respect to the back surface 3b can be suppressed.

As shown in FIG. 6B, the back surface 7b of the grain transfer separator 7 has releasability with respect to the front surface 3a of the skin layer 3. Hence, in the demolding process, the back surface 7b of the grain transfer separator 7 can be easily peeled from the front surface 3a of the skin layer 3.

As shown in FIG. 5B, in the intermediate layer printing process, the intermediate layer 4 is arranged on the back surface 3b of the skin layer 3 by printing (silk screen printing machine). Hence, variation in layer thickness (thickness in the front-back direction) of the intermediate layer 4 can be suppressed compared to, for example, a case where the intermediate layer 4 is arranged by coating. The intermediate layer 4 can be suppressed from being excessively increased in layer thickness. The same applies to the design layer 5 shown in FIG. 6A. Positional deviation in the layer direction among the three layers (skin layer 3, intermediate layer 4, and design layer 5) can be suppressed.

A case is assumed where the design layer 5 has a lower light transmitting property than the intermediate layer 4. In this case, light is more likely to be transmitted through the intermediate layer 4 than through the design layer 5. Hence, when the backlight is off, the design layer 5 (that is, the wood grain pattern) is likely to be transmitted through the intermediate layer 4 and transparently displayed on a front surface of the skin layer 3.

In this regard, according to the decorative sheet 1 of the present embodiment, the design layer 5 has a higher light transmitting property than the intermediate layer 4. Hence, light is less likely to be transmitted through the intermediate layer 4 than through the design layer 5. Accordingly, when the backlight is off, the design layer 5 can be suppressed from being transmitted through the intermediate layer 4 and transparently displayed on the front surface of the skin layer 3.

The skin layer 3 includes the grain part 31 on the front surface. Hence, when the backlight is off, light from outside can be diffusely reflected between the concave portions and convex portions of the grain part 31. Accordingly, a boundary portion (as an example, in the case where the design layer 5 has a wood grain pattern, a portion where the wood grains show a striking contrast in shade) of the design layer 5 can be blurred. Thus, the boundary portion of the design layer 5 can be suppressed from being transparently displayed on the front surface of the skin layer 3. When the backlight is on, a three-dimensional design can be displayed on the front surface of the skin layer 3. The skin layer 3 is colorless and transparent, and has a higher light transmitting property than the design layer 5 and the intermediate layer 4. Hence, the grain part 31 becomes apparent mainly when the backlight is off.

The decorative sheet 1 is arranged on the door trim 9. Hence, by switching the backlight on and off, duality can be provided to the design and texture of the door trim 9. Specifically, a leather-like design can be displayed on the door trim 9 when the light source part 90 is off, and a wood grain-like design can be displayed on the door trim 9 when the light source part 90 is on.

### Others

The embodiments of the method for manufacturing a laminated member of the present disclosure have been described above. However, the embodiments are not particularly limited to the above. It is also possible to implement in various modified forms and improved forms that can be made by those skilled in the art.

### (regarding Configuration)

The layer structure of each layer (skin layer 3, intermediate layer 4, and design layer 5) of the decorative sheet 1 is not particularly limited, and may be a single layer structure or a multilayer structure. Among each layer, another layer may be interposed between two layers adjacent in the front-back direction. Another layer may be arranged on the back side of the design layer 5 or the front side of the skin layer 3.

The shape and the like (such as shape (shape in the layer direction or shape in the lamination direction), size, number arranged, and position) of the concave portion 31a of the grain part 31 of the skin layer 3 are not particularly limited. The same applies to the convex portion 31b of the grain part 31. The concave portion 31a and the convex portion 31b may be arranged regularly or irregularly. The pattern of the grain part 31 is not particularly limited. Examples of the pattern of the grain part 31 include patterns containing at least one selected from leather pattern, wood grain pattern, rock grain pattern, sand pattern, pear skin pattern, fabric pattern, and geometric pattern.

The design of the design layer 5 is not particularly limited. Preferably, the design of the design layer 5 is a design different from the design (such as grain part 31) of the skin layer 3 and the design (such as color) of the intermediate layer 4. In this way, duality can be provided to the design displayed on the front surface 3a of the skin layer 3 in response to the backlight being turned on and off. Examples of the design of the design layer 5 include designs containing at least one selected from patterns (such as wood grain pattern, marble pattern, stone wall pattern, polka dot pattern, striped pattern, and lattice pattern), characters (such as alphabet, hiragana, katakana, kanji, numeral, and braille), figures (such as polygon and circle), and symbols (such as button for device operation and icon indicating device status).

The color of the design displayed on the skin layer 3 may be a single color or multiple colors. The color may be expressed on the skin layer 3 by at least one selected from each layer and the light source part 90. The light transmitting property of each layer is not particularly limited. Each layer may be colorless and transparent, colored and transparent, translucent, or the like. The degree of light transmitting property between the design layer 5 and the intermediate layer 4 is not particularly limited. The design layer 5 may have a higher light transmitting property or lower light transmitting property than the intermediate layer 4. The design layer 5 and the intermediate layer 4 may have the same light transmitting property. The color (hue, saturation, and brightness) of each layer and the light source 900 is not particularly limited.

The luminance of the light source 900 is not particularly limited. The type, number arranged, and position of the light source 900 are not particularly limited. The light source 900 may be an organic electroluminescent (EL) sheet, an inorganic EL sheet, a phosphorescent sheet, or the like. The light source part 90 may include the light source 900 and a light guide plate (for example, an acrylic plate).

The type of an interior member on which the decorative sheet 1 is arranged is not particularly limited. Examples include the door trim 9, a seat, an armrest, a floor, a ceiling, instrument panels, a glove box, a steering wheel, a center console, and a register. A front surface (front surface 3a of skin layer 3) of the interior member may be a flat surface or a curved surface. The orientation (orientation in the front-back direction of decorative sheet 1) of the interior member is not particularly limited. That is, the front-back direction may be an up-down direction, a horizontal direction, or a direction intersecting the up-down direction and the horizontal direction. The decorative sheet 1 may be arranged on an interior member of transportation equipment (such as motorcycles, ships, and aircraft) other than vehicles, buildings (such as buildings and houses) or the like. The decorative sheet 1 may be arranged on an exterior member (such as an exterior wall of transportation equipment, buildings or the like). The type of the laminated member is not particularly limited. The laminated member may be a sheet (sheet not requiring the light source part 90) other than the decorative sheet 1, and may be, for example, an anti-slip sheet or a building material.

### Regarding Material

A material of the skin layer 3 is not particularly limited. Examples include synthetic leather, resin, and elastomer. Specific examples include acrylic, polyethylene terephthalate, polycarbonate, polyvinyl chloride, silicone, epoxy, polyurethane, styrene-based thermoplastic elastomer, olefin-based thermoplastic elastomer, and dynamically crosslinked thermoplastic elastomer. The skin layer 3 may contain a colorant (such as colored polyethylene), a light diffusing agent (such as silicone, acrylic, and titanium oxide), and a light absorber (such as titanium black and carbon black).

A material of the intermediate layer 4 is not particularly limited. Examples include resin or elastomer, such as acrylic, polyethylene terephthalate, polycarbonate, polyvinyl chloride, silicone, polyester, epoxy, polyurethane, styrene-based thermoplastic elastomer, olefin-based thermoplastic elastomer, and dynamically crosslinked thermoplastic elastomer. The intermediate layer 4 may contain the aforesaid colorant, light diffusing agent, and light absorber.

A material of the design layer 5 is not particularly limited. Examples include resin or elastomer, such as acrylic, polyethylene terephthalate, polycarbonate, polyvinyl chloride, silicone, polyester, epoxy, polyurethane, styrene-based thermoplastic elastomer, olefin-based thermoplastic elastomer, and dynamically crosslinked thermoplastic elastomer. The design layer 5 may contain the aforesaid colorant, light diffusing agent, and light absorber.

In the case where each layer has light diffusivity, a method for imparting the light diffusivity is not particularly limited. For example, in a transparent base material, a light diffusing agent (such as silicone, acrylic, and titanium oxide) having a refractive index different from that of the base material may be dispersed.

### Regarding Method for Manufacturing Laminated Member

The printing method in the intermediate layer printing process shown in FIG. 5B and the design layer printing process shown in FIG. 6A is not particularly limited. Screen printing (such as silk screen printing), gravure printing, inkjet printing, flexographic printing or the like may be used. The difference in the printing method used in the intermediate layer printing process and the design layer printing process is not particularly limited.

The design layer printing process shown in FIG. 6A may not be performed. That is, the design layer 5 may be laminated on the intermediate layer 4 by adhesion, crimping, attachment, vapor deposition, welding, coating, or the like. For example, the design layer 5 may be adhered to the back surface of the intermediate layer 4. The design layer 5 may be coated on the back surface of the intermediate layer 4.

The laminated sheet B (strip-shaped long continuous body) of FIG. 5A may not be cut and the subsequent processes (intermediate layer printing process shown in FIG. 5B, design layer printing process shown in FIG. 6A, and demolding process shown in FIG. 6B) may be performed. That is, the decorative sheet 1 of a predetermined shape may be completed at a stage before being arranged on the door trim 9 shown in FIG. 1.

The method for manufacturing a laminated member may include a process other than the intermediate layer printing process shown in FIG. 5B and the design layer printing process shown in FIG. 6A. For example, on the back side of the design layer 5, a diffusion layer having light diffusivity may be arranged in order to diffuse light from multiple light sources (point light sources) 900 of the light source part 90. In this case, after the design layer printing process, a diffusion layer printing process may be performed in which the diffusion layer is printed onto a back surface of the design layer 5.

In the molding process shown in FIG. 5A, the state of the raw material A before molding of the front surface (to-be-molded surface) 3a is not particularly limited. The state may be a liquid state, a fluid state, a solid state, or the like. As shown in FIG. 5B, the grain part 31 may be arranged on the front surface 3a after the molding process.

In the molding process, a method for molding the front surface 3a (that is, grain part 31) by the back surface (molding surface) 7b is not particularly limited. Example include injection molding, extrusion molding, and press molding. As an example, in the case where the front surface 3a is molded by injection molding, the back grain part 71 may be arranged on a mold surface (molding surface) of a mold (molding die member), the raw material in a liquid state A may be injected into a cavity of the mold, and the front surface 3a may be molded by cooling and hardening the raw material A. The printing process after the molding process may be performed while the front surface 3a remains in close contact with the mold surface of the mold.

1. A method for manufacturing a laminated member, the laminated member comprising a printed layer and a printing layer, the printed layer having a to-be-molded surface that includes a grain part having an uneven shape, and a printed surface facing away from the to-be-molded surface, the printing layer being printed onto the printed surface, in which the laminated member is manufactured using a molding die member having a molding surface that includes a back grain part having an uneven shape and being die-symmetric with respect to the grain part, the method comprising:
a molding process in which the to-be-molded surface is molded by the molding surface; and
a printing process in which the printing layer is printed onto the printed surface while the to-be-molded surface remains in close contact with the molding surface, wherein
the laminated member is a decorative sheet comprising a skin layer having a light transmitting property, an intermediate layer having a light transmitting property and arranged on a back side of the skin layer, and a design layer having a light transmitting property and arranged on a back side of the intermediate layer;
the printed layer is the skin layer, the to-be-molded surface is a front surface of the skin layer, and the printed surface is a back surface of the skin layer;
the printing layer is the intermediate layer;
the printing process is an intermediate layer printing process in which the intermediate layer is printed onto the back surface of the skin layer while the front surface of the skin layer remains in close contact with the molding surface; and
the method further comprises a design layer printing process in which the design layer is printed onto a back surface of the intermediate layer.

2. The method for manufacturing a laminated member according to claim 1, wherein
a light source part is arranged on a back side of the design layer.

3. The method for manufacturing a laminated member according to claim 2, wherein
the light transmitting property of the skin layer, the intermediate layer, and the design layer is set in order from high to low as follows: the skin layer, the design layer, and the intermediate layer; and
in a case where the light source part is off, the skin layer and the intermediate layer are easily visible from a front side of the decorative sheet, and in a case where the light source part is on, the design layer is easily visible from the front side of the decorative sheet.
